(19) United States
(12) Patent Application Publication
(10) Pub. No.: US 2011/0024597 A1
(43) Pub. Date: Feb. 3, 2011

(54) SUPPORT ASSEMBLY

(75) Inventor: You Quang Tan, GuangDong (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: UNITED CHINESE PLASTICS PRODUCTS COMPANY LIMITED, Kowloon (HK)

(21) Appl. No.: 12/755,423

(22) Filed: Apr. 7, 2010

Related U.S. Application Data
(60) Provisional application No. 61/230,752, filed on Aug. 3, 2009.

(51) Int. Cl. F16M 11/22

(52) U.S. Cl. 248/440.1

(57) ABSTRACT

A support assembly comprises a tubular member having a receiving opening at a first end for receiving an object inserted into the tubular member, a plurality of support legs each pivotably connected to the tubular member and adapted to pivot between a first position where the support legs are unfolded with respect to the tubular member and a second position where the support legs are folded with respect to the tubular member; a ring slidably attached around the tubular member; and a plurality of linking rods each connected between the corresponding support leg and the ring.

### CROSS-REFERENCE TO RELATED APPLICATION

This application claims the priority benefit of U.S. provisional application Ser. No. 61/230,752, filed on Aug. 3, 2009. The entirety of the above-mentioned patent application is hereby incorporated by reference herein and made a part of specification.

### BACKGROUND OF THE INVENTION

1. Field of the Invention

The present invention relates to a support assembly, and more particularly, to a support assembly capable of easy unfolding and folding.

2. Description of Related Art

Every year as the Christmas Day approaches, people usually place a Christmas tree at home for celebration. Stands for supporting and fixing the Christmas trees must have sufficient structure strength to stably support and fix the Christmas trees. As a result, the stands usually are bulky. The stands are not used after the Christmas Day and therefore need to be stored. However, due to its bulky size, a large space would be required for storage of the conventional stands.

This type of support assemblies typically include multiple detachable components to allow for storage when these components are in a detached state so as to save storage space. However, a lot of time and effort would be required for assembling and disassembling the support assembly, which causes inconvenience in the use of the support assembly.

### SUMMARY OF THE INVENTION

Accordingly, the present invention is directed to a support assembly capable of easy unfolding and folding.

The present invention provides a support assembly for supporting an object. The support assembly includes a tubular member, a plurality of support legs, a plurality of first linking rods, and a plurality of second linking rods. The tubular member has a receiving opening, a first end, and a second end. The receiving opening is disposed at the first end of the tubular member and the object is adapted to be inserted into the tubular member via the receiving opening. Each support leg has a first end and a second end. The first end of each of the support legs is pivotably connected to the tubular member. The support legs are adapted to pivot between a first position where the support legs are unfolded with respect to the tubular member and a second position where the support legs are folded with respect to the tubular member. The second end of each of the support legs extends in a direction away from the second end of the tubular member. Each first linking rod has a first end and a second end. The first ends of the first linking rods are pivotably connected to the second ends of the support legs, respectively. Each second linking rod has a first end and a second end. The first ends of the second linking rods are pivotably connected to the second ends of the first linking rods, respectively, and the second end of each of the second linking rods is pivotably connected to the tubular member.

According to one embodiment of the present invention, the second end of each of the first linking rods includes a supporting portion. The supporting portions of the first linking rods are supported on the second linking rods, respectively, when the support legs are at the first position.

According to one embodiment of the present invention, the length of each of the first linking rods is greater than the length of the corresponding one of the second linking rods. The first linking rods and the second linking rods are folded into the support legs when the support legs are at the second position.

According to one embodiment of the present invention, when the support legs are at the first position, the extending direction of the first linking rods is substantially the same as the extending direction of the second linking rods but substantially perpendicular to the extending direction of the tubular member.

According to one embodiment of the present invention, the support assembly further comprises a fixing sleeve disposed at the first end of the tubular member for fixing the object.

The present invention additionally provides a support assembly for supporting an object. The support assembly includes a tubular member, a plurality of support legs, a ring, and a plurality of first linking rods. The tubular member has a receiving opening, a first end, and a second end. The receiving opening is disposed at the first end of the tubular member and the object is adapted to be inserted into the tubular member via the receiving opening. Each support leg has a first end and a second end. The first end of each of the support legs is pivotably connected to the tubular member. The support legs are adapted to pivot between a first position where the support legs are unfolded with respect to the tubular member and a second position where the support legs are folded with respect to the tubular member. The second end of each of the support legs extends in a direction away from the second end of the tubular member. The ring is slidably attached around the tubular member. Each first linking rod has a first end and a second end. The first ends of the first linking rods are pivotably connected to the second ends of the support legs, respectively, and the second end of each of the first linking rods is pivotably connected to the ring.

According to one embodiment of the present invention, the first linking rods are received in the support legs when the support legs are at the second position.

According to one embodiment of the present invention, the support assembly further includes an annular decorative plate disposed on the tubular member.

According to one embodiment of the present invention, the support assembly further includes a fixing sleeve disposed at the first end of the tubular member for fixing the object.

In view of the foregoing, with pivot connection among the support legs, linking rods and tubular member, the support assembly of the present invention is capable of easy unfolding and folding.

In order to make the aforementioned and other features and advantages of the present invention more comprehensible, embodiments accompanied with figures are described in detail below.

### BRIEF DESCRIPTION OF THE DRAWINGS

FIG. 1 is a perspective view of a support assembly according to one embodiment of the present invention, which is shown supporting an object thereon.

FIG. 2 is a view showing a folded state of the support legs of the support assembly of FIG. 1.

FIGS. 3A to 3C are front views showing the unfolding process of the support leg of FIG. 1 with respect to the tubular member.

FIG. 4 is a perspective view of a support assembly according to another embodiment of the present invention, which is shown supporting an object thereon.

FIG. 5 is a view showing a folded state of the support legs of the support assembly of FIG. 4.

### DESCRIPTION OF THE EMBODIMENTS

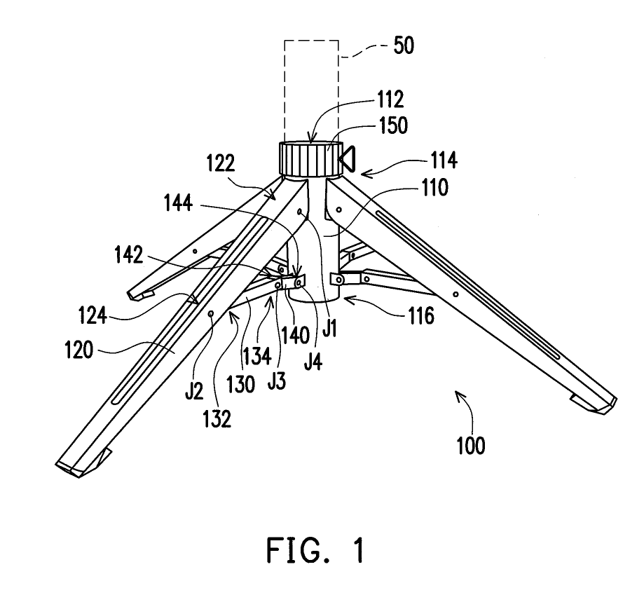

FIG. 1 is a perspective view of a support assembly according to one embodiment of the present invention, which is shown supporting an object thereon. Referring to FIG. 1, the support assembly 100 is used to support an object 50 (indicated by the broken line) such as a Christmas tree. Namely, the support assembly 100 may be used to support a Christmas tree to stably erect the Christmas tree. The support assembly 100 includes a tubular member 110, a plurality of support legs 120, a plurality of first linking rods 130, and a plurality of second linking rods 140. The tubular member 110 has a receiving opening 112, a first end 114, and a second end 116. The receiving opening 112 is positioned at the first end 114 and the object 50 is adapted to be inserted into the tubular member 110 via the receiving opening 112. In the present embodiment, the tubular member 110 is, for example, a round tube in shape. However, the particular shape described herein is for the purposes of illustration only and is in no way limiting. In another embodiment not illustrated, the tubular member 110 may also be a square tube or an oval tube in shape.

Each support leg 120 has a first end 122 and a second end 124. The first end 122 of each support leg 120 is pivotably connected to the tubular member 110 to form a plurality of joints J1. In addition, the second end 124 of each support leg 120 extends in a direction away from the second end 116 of the tubular member 110. In the present embodiment, the number of the support legs 120 is four and the joints J1 are substantially distributed at four quarter-points of the circumference of the tubular member 110.

Each first linking rod 130 has a first end 132 and a second end 134. The first end 132 of each first linking rod 130 is pivotably connected to the second end 124 of one corresponding support leg 120 to form a plurality of joints J2. Each second linking rod 140 has a first end 142 and a second end 144. The first end 142 of each second linking rod 140 is pivotably connected to the second end 134 of one corresponding first linking rod 130 to form a plurality of joints J3. The second end 144 of each second linking rod 140 is pivotably connected to the tubular member 110 to form a plurality of joints J4. In the present embodiment, the joints J4 are substantially distributed as four quarter-points of another circumference of the tubular member 110.

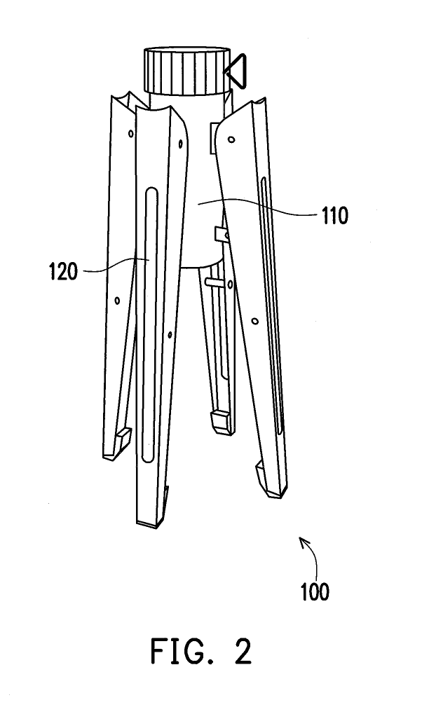

FIG. 2 is a view showing a folded state of the support legs of the support assembly of FIG. 1. Referring to FIG. 1 and FIG. 2, the support legs 120 are adapted to pivot between a first position (as shown in FIG. 1) where the support legs 110 are unfolded with respect to the tubular member 110 and a second position (as shown in FIG. 2) where the support legs 110 are folded with respect to the tubular member 110. When unfolded with respect to the tubular member 110, the support legs 120 can stably contact the ground thus providing a good support to the object 50. For storage of the support assembly 100, it is only needed to fold the support legs 120 down to the tubular member 110. After folding of the support assembly 100, the storage space for the support assembly 100 can also be significantly reduced. Besides, when the support legs 120 are folded down to the tubular member 110, the support assembly 100 is generally cylinder-shaped and can thus easily held and stored.

More specifically, the support assembly 100 may further include a fixing sleeve 150 disposed at the first end 114 of the tubular member 110 for fixing the object 50.

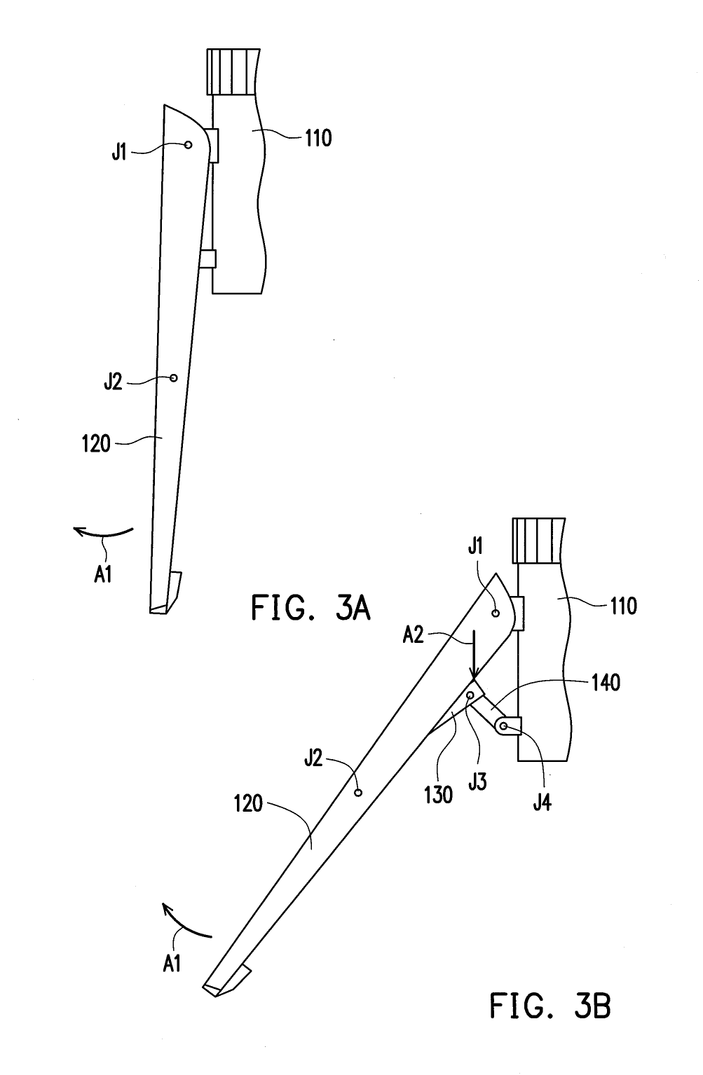

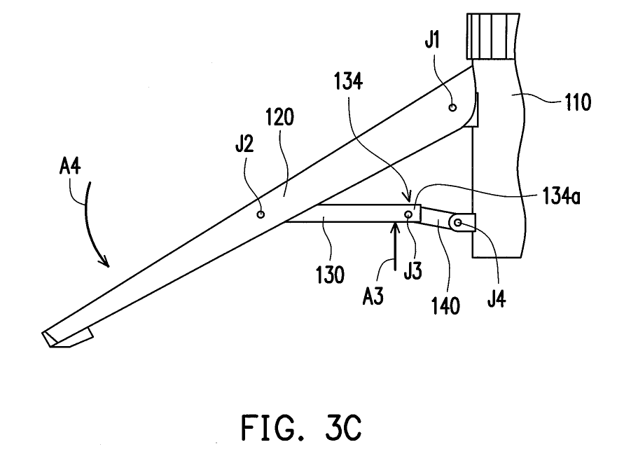

FIGS. 3A to 3C are front views showing the unfolding process of the support leg of FIG. 1 with respect to the tubular member. Referring to FIG. 1 and FIG. 3A, the length of each first linking rod 130 may be greater than the length of the corresponding second linking rod 140. When the support legs 110 are at the second position, each first linking rod 130 and each second linking rod 140 are folded into the corresponding support leg 120. Namely, when the support legs are folded with respect to the tubular member 110, the first linking rods 130 and the second linking rods 140 are not exposed thus making the support assembly 110 look aesthetic.

Referring to FIGS. 3A and 3B, when a user exerts a force on the support leg 120 in a first direction A1, the support leg 120 pivots about the joint J1 in a clockwise direction with respect to the tubular member 110. The user then may exert a force on the joint J3 in a second direction J3 to cause the first link rod 130 to pivot in a clockwise direction and the second link rod 140 to pivot in counter-clockwise direction. In the present embodiment, the second direction A2 is for example parallel to the extending direction of the tubular member 110.

It is noted that the user needs only to press each joint J3 of the first link rod 130 and the second linking rod 140 downward to fix the position of the first linking rod 130 and the second link rod 140.

Referring to FIG. 3B and FIG. 3C, the support leg 120 continues pivoting in the clockwise direction until the first linking rod 130 is supported on the second linking rod 140. In the present embodiment, the second end 134 of each first linking rod 130 has a supporting portion 134a extending therefrom. When the support leg 120 are unfolded with respect to the tubular member 110 to the first position, the supporting portions 134a of the first linking rods 130 are supported on the second linking rod 140, respectively.

More specifically, when the support leg is at the first position, the extending direction of the first linking rod 130 is the same as the extending direction of the second linking rod 140 but is perpendicular to the extending direction of the tubular member 110. As such, hypothetical lines connecting the joints J1, J2, J4 form an approximate right triangle thereby providing a more stable support by the support assembly 100. When finishing using the support assembly 100, the user can fold the support legs 120 with respect to the tubular member 110 again simply by exerting a force on the joints J3 in a third direction A3 opposite to the second direction A2 and exerting a force on the support legs 120 in a fourth direction A4 opposite to the first direction A1. The above-described unfolding and folding operations can be done by oneself and therefore are very convenient.

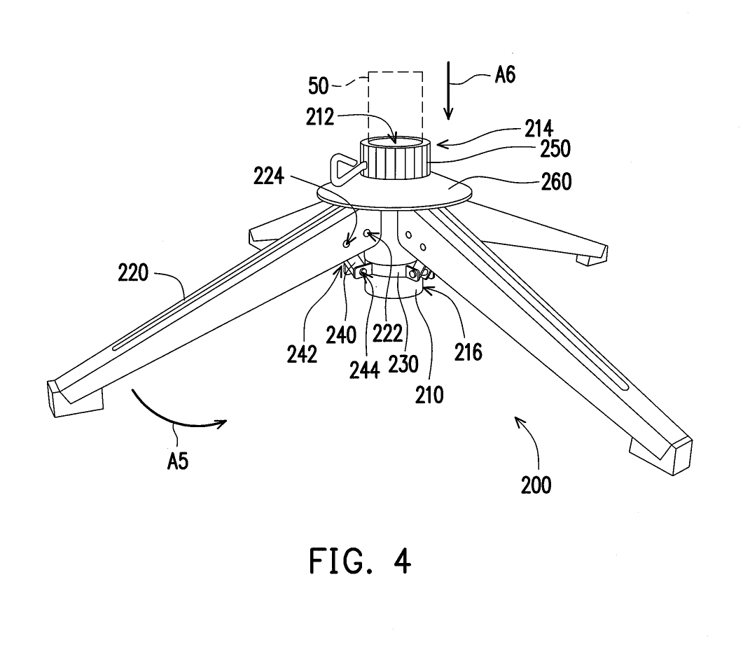

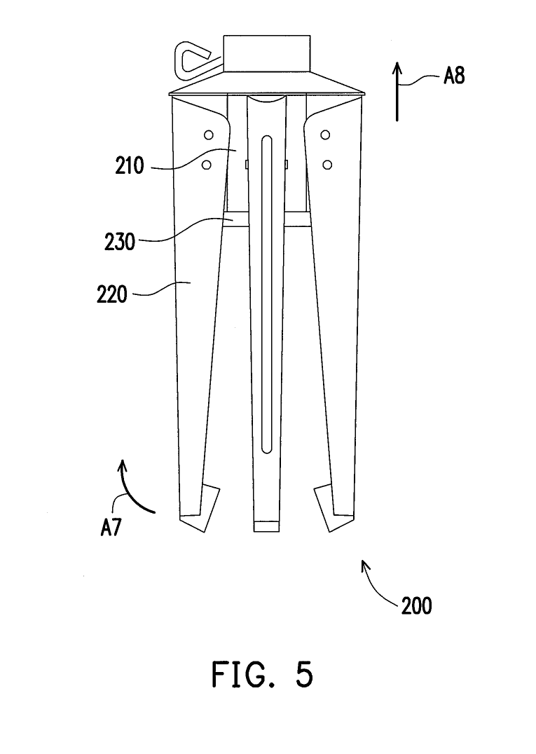

FIG. 4 is a perspective view of a support assembly according to another embodiment of the present invention, which is shown supporting an object thereon. FIG. 5 is a view showing a folded state of the support legs of the support assembly of FIG. 4. Referring to FIGS. 4 and 5, the support assembly 200 may also be used to support the object 50. The support assembly 200 includes a tubular member 210, a plurality of support legs 220, a ring 230, and a plurality of first linking rods 240.

The tubular member 210 has a receiving opening 212, a first end 214, and a second end 216. The receiving opening 212 is positioned at the first end 214 and the object 50 is adapted to be inserted into the tubular member 210 via the receiving opening 212. Each support leg 220 has a first end 222 and a second end 224. The first end 222 of each support leg 220 is pivotably connected to the tubular member 210. In the present embodiment, the support assembly 200 may also include a fixing sleeve 250 disposed at the first end 214 of the tubular member 210 for fixing the object 50.

The support legs 220 are adapted to pivot between a first position (as shown in FIG. 4) where the support legs 210 are unfolded with respect to the tubular member 210 and a second position (as shown in FIG. 5) where the support legs 210 are folded with respect to the tubular member 210. In addition, the second end 224 of each support leg 220 extends in a direction away from the second end 216 of the tubular member 210. The above-described structures are similar to that of the embodiment of FIG. 1 and thus are not repeated herein.

Specifically, the ring 230 of the present embodiment is slidably attached around the tubular member 210. Each first linking rod 240 has a first end 242 and a second end 244 and the first end 242 of each first linking rod 240 is pivotably connected to the second end 224 of one corresponding support leg 220. When the user exerts a force on the support legs 220 in a fifth direction A5, the support legs 220 drive the ring 230 through the first linking rods 240 thus causing the ring 230 to move in a sixth direction A6 parallel to the extending direction of the tubular member 210. The support legs 220 are then positioned at the second position where the support legs 220 are folded with respect to the tubular member 210. When the user folds the support legs 220, the support assembly 200 is in a state as shown in FIG. 5. In addition, when the support legs 220 are folded with respect to the tubular member 210, the first linking rods 240 can be received in the support legs 220.

Reversely, to use the support assembly 200, the user may unfold the support legs 220 with respect to the tubular member 210 in a seventh direction A7 opposite to the fifth direction A5. During the unfolding process, the support legs 220 drive the first linking rods 240 to pivot with respect to the ring 230 and cause the ring 230 to move in an eighth direction A8 opposite to the sixth direction A6. After the user unfolds the support legs 220, the support assembly 200 can thus stably support the object 50. Therefore, the support assembly 200 is simple and convenient to use.

In the present embodiment, the support assembly 200 may also include an annular decorative plate 260 disposed on the tubular member 210 to make the appearance of the support assembly 200 more aesthetic.

In summary, with pivot connection among the support legs, linking rods and tubular member, the support assembly of the present invention is capable of easy unfolding and folding. In addition, because various components of the support assembly are interconnected to become integrated, the support assembly is convenient to hold and store. Besides, assembly of the support assembly can be done by oneself thus reducing the assembly time and cost. Furthermore, because the support leg, linking rod and tubular member can form a triangle structure, the support member can more stably support the object. Moreover, the user can fix the position of the first linking rod and the second linking rod simply by pressing the joint of the first linking rod and the second linking rod downward.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A support assembly for supporting an object, comprising:
a tubular member having a receiving opening, a first end, and a second end, wherein the receiving opening is disposed at the first end of the tubular member and the object is adapted to be inserted into the tubular member via the receiving opening;
a plurality of support legs each having a first end and a second end, wherein the first end of each of the support legs is pivotably connected to the tubular member, the support legs are adapted to pivot between a first position where the support legs are unfolded with respect to the tubular member and a second position where the support legs are folded with respect to the tubular member, and the second end of each of the support legs extends in a direction away from the second end of the tubular member;
a plurality of first linking rods each having a first end and a second end, wherein the first ends of the first linking rods are pivotably connected to the second ends of the support legs, respectively; and
a plurality of second linking rods each having a first end and a second end, wherein the first ends of the second linking rods are pivotably connected to the second ends of the first linking rods, respectively, and the second end of each of the second linking rods is pivotably connected to the tubular member.

2. The support assembly according to claim 1, wherein the second end of each of the first linking rods includes a supporting portion, and the supporting portions of the first linking rods are supported on the second linking rods, respectively, when the support legs are at the first position.

3. The support assembly according to claim 1, wherein the length of each of the first linking rods is greater than the length of the corresponding one of the second linking rods, and the first linking rods and the second linking rods are folded into the support legs when the support legs are at the second position.

4. The support assembly according to claim 1, wherein, when the support legs are at the first position, the extending direction of the first linking rods is substantially the same as the extending direction of the second linking rods but substantially perpendicular to the extending direction of the tubular member.

5. The support assembly according to claim 1, further comprising a fixing sleeve disposed at the first end of the tubular member for fixing the object.

6. A support assembly for supporting an object, comprising:
a tubular member having a receiving opening, a first end, and a second end, wherein the receiving opening is disposed at the first end of the tubular member and the object is adapted to be inserted into the tubular member via the receiving opening;
a plurality of support legs each having a first end and a second end, wherein the first end of each of the support legs is pivotably connected to the tubular member, the support legs are adapted to pivot between a first position where the support legs are unfolded with respect to the tubular member and a second position where the support legs are folded with respect to the tubular member, and the second end of each of the support legs extends in a direction away from the second end of the tubular member;
a ring slidably attached around the tubular member; and
a plurality of first linking rods each having a first end and a second end, wherein the first ends of the first linking rods are pivotably connected to the second ends of the support legs, respectively, and the second end of each of the first linking rods is pivotably connected to the ring.

7. The support assembly according to claim 6, wherein the first linking rods are received in the support legs when the support legs are at the second position.

8. The support assembly according to claim 6, further comprising an annular decorative plate disposed on the tubular member.

9. The support assembly according to claim 6, further comprising a fixing sleeve disposed at the first end of the tubular member for fixing the object.
